(19) United States
(12) Patent Application Publication
(10) Pub. No.: US 2007/0162338 A1
(43) Pub. Date: Jul. 12, 2007

(54) US savings bond gift system and method to redeem a gift card for a US savings bond through internet redemption

(76) Inventor: Tabbatha Christie Lawe, Chapel Hill, NC (US)

Correspondence Address: ALUN L. PALMER, PATENT AGENT, 4300 PINEY CHURCH ROAD, WALDORF, MD, 20602, US

(21) Appl. No.: 11/599,506

(22) Filed: Nov. 13, 2006

Related U.S. Application Data
(60) Provisional application No. 60/737,626, filed on Nov. 17, 2005.

(51) Int. Cl. G07G 1/14

(52) U.S. Cl. 705/14

(57) ABSTRACT

The invention provides a system and method for a donor to purchase a combined greeting-card and stored-value POSA card to be given to a recipient who can redeem the stored-value associated with the POSA card for a US savings bond through the recipient's completion of HTML forms including the entering of the recipient's social security number and unique gift card number. The system captures and sends the recipient's information including the recipient's social security number to the appropriate issuing agent for issuance of the US savings bond.

This application claims benefit of my provisional application 60/737,626 filed Nov. 17,2005.

### BACKGROUND OF THE INVENTION

1. Field of the Invention

This invention relates generally to systems and methods for a US savings bond gift system and method to allow donors to efficiently purchase and give US savings bonds as a gift to recipients by purchasing a combination gift-card and point-of-sale activated stored-value card at retail locations which can subsequently be redeemed by the recipient though an internet redemption process using the recipient's social security number and the unique number associated with the stored-value card.

2. Background of the Invention

Since at least 2002, US savings bond EE sales have been declining by an average of 14% a month using a month-to-prior-year-month comparison. The long-term impact of fewer US savings bond sales has not been adequately measured, but as the population of The United States grows, it is clear that the percent of individual US citizens who support their government through the purchase of US savings bond is dropping at a time when government borrowing is at an all time high. Extensive historical efforts by the US Treasury to promote the purchase of US savings bonds have highlighted the patriotic value realized by citizens who make such purchases. The recent drop of US savings bond sales and the lack of US savings bonds given as gifts are eroding the sense of patriotism associated with US savings bond purchases. Moreover, because fewer US citizens are purchasing savings bonds for themselves or as gifts for others, the US Treasury and the US economy are becoming more and more dependent on foreign countries such as China and Japan to fund US government debt. An Oct. 25, 2005 article in the online magazine “Atlantic Online” states: “China, is the United States' second-largest lender, after Japan. China's investment in U.S. government debt has more than tripled in the past five years, from $71 billion in 2000 to $242 billion in 2005.”

There are several existing purchase method factors which contribute to the precipitous decline in the purchase of US savings bonds by US citizens. The physical issuance of US savings bonds follows an existing regulated, complex and time consuming method. Moreover, the compensation provided by the US Treasury department to licensed US savings bond issuing agents does not cover the full cost to issue the bond. Thus, under the current method, issuing US savings bonds is a money losing proposition for nearly all issuing agents and this creates a disincentive to proactively promote and sell US savings bonds especially as gifts. Nearly all issuing agents are banks, and the fee paid by the US Treasury Department for issuing a US savings bond ranges from $0.50 to $0.85 per bond issued. This fee generally does not cover the cost of a bank teller's time to provide the forms, review the form and otherwise complete the process to issue the US savings bond. If a bank where to properly account for the full cost of processing and managing the US savings bond transaction it would show a clear loss for issuing US savings bonds. This current level of US Treasury compensation inhibits the active promotion of US savings bonds by bank issuing agents. The net-effect of this low compensation is that banks no longer actively promote or market US savings bonds to customers. They provide the service as a value-added benefit at a loss to customers of the bank when asked, but do not proactively promote US savings bonds. This lack of marketing and promotion by the primary US savings bond issuing agents/banks has led to the serious decline in US savings bonds.

Secondly, customer visits to banks have fallen precipitously. According to Synergistics Research, consumer visits to bank branches dropped 37% from 1995 to 2002. There is a well-known bromide in retail that says the three most important elements of retail success are: location, location and location. Because fewer people are going to banks, banks are the becoming the wrong location to sell US savings bonds. The lack of bank branch visits translates into fewer opportunities for a bank to promote or issue US savings bonds. Fewer bank visits clearly means fewer US savings bond sales.

Third, a large portion of US savings bonds are issued as gifts and the current method to sell US savings bonds as a gift is onerous for the donor and decidedly disadvantageous for the donor compared to buying and giving other gifts of similar value. In most cases, the US savings bond gift donor must physically visit a bank, acquire and complete the paperwork for the gifted US savings bond and submit the completed paperwork back to the bank teller. This method of buying a US savings bond adds significant cost to the donor in terms of time and energy over and above the cost of the US savings bond or any other purchase for a similar costing gift item. It is also important to note that after making the purchase, the donor may or may not receive a paper gift-certificate from the bank teller to present to the recipient. A lack of a physical form factor which acts as substitutes for the US savings bond is a further barrier for gift giving. Donors who purchase a gift US savings bond and have no physical form factor to present to the recipient for the gift, are left to their own devices in describing the gift of the US savings bond to the recipient. This is a cumbersome barrier and one which dissuades donors from purchasing the US savings bond gift using the current method. To make matters worse, in most cases, the donor often makes a second trip to a traditional retail outlet to purchase a greeting card, such as a birthday card, graduation card or congratulation for the new-baby card, in which the donor notes the US savings bond gift. This extra trip adds further time and effort costs to the transaction under the current method.

Fourth, the sale of US savings bonds as gifts is further hampered by the requirement that each US savings bond must have a valid Social Security number associated with it. Donors will often fail to buy a US savings bond as a gift because they do not know the gift recipient's social security number. Many donors do not know that they can use their own social security number when buying the gift, but even if they do understand it within the current method, the donor will often recognize the use of the donor's social security number creates yet another level of complexity and cost for the recipient who must still execute a process to assign their own social security number to the received US savings bond. Donors are also concerned that the use of the donor's social security number may inadvertently lead to the gift recipient seeing the donor's social security number, thereby compromising the donor's privacy and opening the donor to identity theft. These added hassles and impediments in the current method are hidden costs in giving a US savings bond as a gift and the current method of US savings bond gift-giving creates a significant barrier for the donor.

Fifth, the donor of a US savings bond must provide the recipient's address so the Treasury or appropriate Federal Reserve Bank can send the recipient the physical form for the US savings bond. This requires that the donor to have the recipient's address at the point of purchase. If the donor does not have the recipient's address, the donor is allowed to use their own address, but once the actual US savings bond certificate arrives, the donor is beholden to deliver the certificate to the recipient. Once again, this added hassle within the current method of US savings bond gift purchasing is a hidden cost and creates a significant barrier and disincentive for the donor.

Sixth, the lack of new retail outlets has hampered the sale of US savings bond. Since 1995, banks have reduced full-service branch bank locations dramatically. Moreover, the traditional location for purchasing items, and particularly gift items, is in retail locations. Heretofore, retailers did not have the proper systems nor did they have the required manpower nor were they licensed to effectively accept and process registration forms for issuing US savings bond to buyers. Retailers do not want to sell US savings bond under the current issuing agent model because of costs and complexity associated with the issuing transaction and regulations for issuing US savings bonds. However, these same retailers have become highly proficient at marketing and selling POSA (Point-of-sale-activated) stored-value cards. POSA stored-value cards are cards which are purchased by consumers at retail locations. At purchase, a card is activated using the retailers existing POS transaction system and a value is assigned to the unique card purchased. This allows the retailer to sell a gift-proxy for the eventual item. For instance, at the grocery chain Safeway, a donor can buy a gift-card for rentals a Blockbuster Video, a gift certificate for dinner at Chili's restaurant or for book purchases at Barnes and Nobles books stores. None of these sales at Safeway are for the actual item or service. Safeway has sold a proxy which can be redeemed for the service identified on the card. At purchase, the donor pays the retailer for the full face-value of the card and a database entry is then made on a card-tracking system that associates the purchased gift card with the specific value of the card. At a later time, the activated card can be redeemed by the buyer or by a gift recipient of the buyer, to exchange the stored value associated with the card as recorded in the database for specific goods or services. Retailers prefer selling these point-of-sale stored-value cards because the inventory costs and the potential for theft is low while the retailer can expand into new lines of services or products. An inactivated card on the retailer's shelf is worth no more than a few pennies, but a fully activated card can be worth hundreds of dollars in revenue. Since activation occurs at check-out, the risk of theft is minimal for the retailer.

Seventh, in addition to the inhibitors identified for the donor, the process for a gift recipient to accept the value of the US savings bond as a gift is also overly complex. When a gift of a US savings bond is given, at best the gift recipient often only gets a simple gift certificate. The gift certificate generally relays limited information; usually only that a US savings bond of a certain amount is pending. The gift recipient is not informed of other aspects of the US savings bond. The recipient is not advised on information sources for the US savings bond. Further, in many cases the recipient will be required to update the recipient's social security number or address to allow for the proper assignment of the US savings bond.

Eighth, the US Treasury department has recognized the ubiquity and cost advantages of sale transactions of US savings bonds on the internet and has made purchasing US savings bonds relatively easy and simple on the web. However, while the Treasury has made the transaction easier to execute on the web, the Treasury has not appropriately stepped up marketing efforts to inform buyers that US savings bond sale transactions can be completed on the web. At the same time, the Treasury does not have the funds to promote US savings bonds, the traditional issuing agent cannot afford to promote the US savings bond option either because of the cost issues mentioned earlier. This lack of marketing to US citizens by either the Treasury or the traditional issuing agent has resulted in fewer and fewer Series EE bond sales. Many donors are older US citizens purchasing US savings bonds for grand-children or younger nieces and nephews. Many older citizens have not adopted web-based purchasing in the same percentage and the same comfort level as the gift recipient's generation. The current method allows for severely restricted promotion of US savings bond sales.

Ninth, the current method which requires the combination of the donor purchasing and entering required data for the US savings bond, the delays incumbent in receiving the actual US savings bond certificate and the frequent requirement for subsequent recipient information updates leads to frequent instances where the owner of the bond is not clearly identified by the proper Social Security number, name and address of the recipient. As such, the bonds are often not properly accounted for by the donor, the gift recipient or the Treasury. In time, the bonds become forgotten and eventually are considered lost property. The Treasury Department has a unit that works to find bond owners. Both gift donors as well as recipients see this potential of forgotten bonds as a detriment to the current method. Rather than taking the risk of losing the US savings bond value over time, many donors simply choose a different gift for the recipient.

### OBJECTS AND ADVANTAGES

Accordingly, several objects and advantages of my invention are providing a gift system and method to allow donors to efficiently give US savings bonds as a gift to recipients by purchasing a combination gift-card and point-of-sale activated (POSA) stored value card at retail locations such as retail stores or United States Post Office locations which can subsequently be redeemed by the recipient though an internet redemption process using the recipient's social security number and a unique number associated with the stored value card. The gift of the combination gift-card and POSA stored-value card can be given by the donor to the intended recipient who then follows the instruction printed on the greeting card to exchange the POSA stored value card for a US savings bond by filling out appropriate web-forms including the provision of the recipient's Social Security number, which the system then transmits electronically to the US Treasury or to a federal reserve bank as required by the Treasury department for the proper issuing of the US savings bond to the recipient. The system provides the donor with the ability to efficiently fulfill her intention of giving a recipient a gift of a US savings bond within just one simple transaction which requires no additional data entry by the donor or exposure of donor's private information. Moreover, because the US savings bond is not itself physically issued at the time the combination greeting-card with POSA stored-value card is purchased, it can be sold in any number of retail locations and does not require the retail location to be recognized as an issuing agent by the Treasury. The ability to purchase the gift-card with POSA stored value card at retail locations, will increase the likelihood of more US savings bond sales. More US savings bond sales will increase the sense of patriotism in the population while making the gift process simpler for the donor. Further, since retail outlets would be selling the combination greeting card and gift card only, the retailer will not require extensive training for retail employees. When activated at a retail location and given to the recipient, the greeting card with POSA stored-value gift card provides the recipient with all necessary instructions so the gift recipient can exchange the stored-value card for a US savings bond over the internet. When the recipient-choose to redeem the stored value for a US savings bond, at a minimum he/she inputs his/her social security number and stored value gift card unique number into internet based web forms at a gift web site. The system transmits the entered social security number as entered by the recipient along with the associated stored-value cash amount to the appropriate Federal Reserve bank as per the Treasury process. The appropriate Federal Reserve Bank or US Treasury then issues the US savings bond with all the proper information. The invention gift system and method is designed to utilize the gift recipient as the data-entry person rather than the retailer or the donor. The use of the gift recipient for the required data entry provides for more accurate and immediate capture of relevant information without the retailer or the donor spending time to enter or verify data. The use of the gift-recipient also avoids the cost of any other party entering the data. The gift system eliminates many of the inhibitors that a donor faces when considering the gift option. In execution, the gift system provides one retail transaction to fulfill the donor's wish for purchasing a US savings bond as a gift. The donor also does not need to provide the donor's social security number in the gift system. The donor also does not have to provide her own address nor will the donor have to find and enter the recipient's address or social security number. The elimination of these inhibitors will increase the attractiveness of the US savings bond as a gift and increase sales, as well as increase the donor and recipient's sense of patriotism. Moreover, the gift system's use of web-based forms to redeem the stored-value for the US savings bond, ensures the forms can be filled out correctly while also providing automated management and processing of the forms directly with the US Treasury. The use of web-based forms as completed by the donor to initiate the issuance of the US savings bond more closely aligns the cost of an issuing agent with the payments made by the Treasury of $0.85 per transaction to the issuing agent. Accurate input of recipient information will help ensure proper tracking of the US savings bond and fewer US savings bond sales will be forgotten. Furthermore, because the gift system is based on the initial purchase of a combination greeting card and gift card, which provides value above and beyond the US savings bond in the form of the greeting card and the convenience of the retail distribution and simplicity of method, the combination greeting card and gift card can be sold for an amount above the cost of the US savings bond alone. The additional value associated with the joint purchase of the greeting card and gift card will include a built in value for the convenience delivered to the donor. A portion of this additional value captured at purchase can be subsequently used by the retailer and the gift-system operator to actively promote US savings bond sales to consumers which will, in turn, increase a sense of patriotism in more US citizens.

### SUMMARY OF THE INVENTION

The preferred embodiments of the present invention provides a system and method for a donor to purchase a greeting-card and stored-value point-of-sale-activated (POSA) card to be given to a recipient who can redeem the stored-value associated with the POSA card for a US savings bond through the recipient's completion of HTML forms including the entering of the recipient's social security number and unique gift card number which is transmitted by the system to the US Treasury for final US savings bond issuance and recording.

A database of POSA unique card records is created by randomly issuing unique alpha-numeric characters in individual card records within a card database. The unique alpha-numeric characters can be one or two strings of different and unique alpha-numeric characters placed in one or two fields within the database. Additionally, a denomination value is assigned to each record in the database. In one embodiment of the invention, the denomination value assigned is one of the face-values of standard US EE Savings bonds. For instance, $50.00, $75.00, $100.00 and $200.00. Next, blank POSA stored-value cards are processed such that at the fields of one card record are associated and assigned to a one physical POSA stored-value card. Once associated with a card, the database record locks the unique alpha-numeric character strings from being used on any other stored-value card. The association form on the physical card is through at least one appropriate form such as encoding a unique alpha-numeric character string on a magnetic stripe on the card, associating the unique alpha-numeric character string through a printed bar-code on the card or through printing the alpha-numeric string as characters directly on the plastic card. In the preferred embodiment, two unique alpha-numeric character strings are recorded in one record within the database of POSA unique card records and both strings are associated with one POSA card. One string is embedded as machine readable within a magnetic stripe or machine-readable as printed using a bar-code on each card and one string is printed on the card directly in human-readable form. During the POSA card processing, the printed alpha-numeric character string in human-readable form that is associated with the card is next covered with a scratch-off film. Thus, in the preferred embodiment of the invention, each associated POSA stored-value card will have a printed denomination on the front representing a US savings bond value, a magnetic stripe or bar-code representing a unique alpha-numeric character string, and a second printed alpha-numeric character string readable by human eye, which is covered by a scratch-off film. The card will therefore, represent the critical elements recorded in the POSA card database.

Once the POSA stored-value card is in this state, it is bundled with a greeting card for sale at a retail location. In the preferred embodiment, the greeting card has a patriotic theme which further re-enforces the patriotic values a donor and recipient will receive when handling the US savings bond gift card and greeting card.

The combination greeting-card and attached POSA stored-value card hold detailed information for the execution of the gift system. Both the donor and the recipient are informed of the required method to redeem the stored-value for a US savings bond through text explanations within the body of the greeting card and POSA gift card. The donor can read this prior to purchasing the greeting card and the recipient can read the text after receiving the greeting card. The POSA card also displays a US dollar denomination on the front of the card representing the value of the US savings bond.

The greeting card and POSA cards will be made jointly available to donors at any type of retail location accessible by the donor. In the preferred embodiment, there are multiple patriotic images and messages on different greeting cards and POSA stored value gift card. The donor selects a greeting-card and POSA stored-value card which matches the denomination and style preferred by the donor at the retail location. The donor then takes the selected POSA stored-value card and the selected greeting card to the retail location check-out location and pays for the combined gift in one transaction.

In one embodiment, the donor purchases the greeting-card with POSA stored-value card for a single amount equal to one-half the maturity value printed on the stored-value card plus an amount to cover the cost of the greeting card, such as $4.95. Thus, a donor would purchase a greeting card with POSA store-value card that shows a $50.00 US savings bond face-value for a payment of $29.95 before taxes. Likewise, the donor could purchase a different greeting card with POSA stored-value card that shows a $100.00 face-value for $54.95.

Alternatively, the retail associate can charge the donor two separate amounts. One amount could be for the greeting card (e.g. $4.95) and one could be for one-half the face-value printed on the card (e.g. $25 for a $50 face-value).

In another embodiment, the face value of the stored value card is the full value of the bond purchased.

At check-out, the retail associate also activates the POSA stored-value card in the traditional manner of a POSA activation for that retail institution such as by the retail associate swiping the magnetic stripe through a card reader or scanning the bar-code with a bar-code scanner at the point-of-sale and entering any appropriate sequence of key-strokes on the check-out register to signify the activation of the card. The retail activation process utilizes the retailer's POS system in capturing the information embedded on the magnetic stripe or within the bar-code relating to the unique POSA card. Next, the retailer's POS system accesses a network. The captured alpha-numeric character string information relating to the unique POSA card is sent as an electronic message over the retailer's chosen network to a POSA card activation processor system. The POSA card activation processor system accepts the electronic message and updates the POSA database record for the purchased card to indicate that the card has been purchased and is now activated. Other data elements of the electronic message such as time, date and location of activation are captured and stored with the existing card record. The activation processor sends the activated card record to a gift card redemption web site to be stored in an activated card database.

In one embodiment, the POSA card does not need to be activated. The activation step allows for protection against fraud if a POSA card is stolen and the POSA card is subsequently used to purchase a savings bond. Activation at retail allows for confirmation of the card being purchased and paid for at a retail location. However, because the system requires the use of a Social Security number, and because a minimum time of 12 months must pass before a bond can be cashed in for cash, it is unlikely that the POSA card will be stolen. The hurdle of entering a Social Security number and name would automatically identify a potential thief. Moreover, the system can easily identify the entry of multiple purchases using a single Social Security number. Therefore, one embodiment of the system envisions the production and sale of the POSA card with only a scratch-off film and number underneath and NO activation at retail. Thus, the gift donor would simply purchase the greeting card and POSA (with no activation) card.

Once the card is activated or purchased, the gift system also causes the deposit of exactly one-half the face value of the gift card or the full-face value into a stored-value financial account. The stored-value financial account can be resident at a bank or can be resident at the US Treasury.

The system next awaits the recipient's redemption through the gift-system's internet web site. The greeting card and POSA gift card include text instructions to the donor and recipient which explains how the stored-value is to be redeemed for the US savings bond gift. The instructions optimally explain how the recipient may use any computer with web-browser to go to a specified web-address such as www.AmericanGiftBond.com. Once at the location, the gift recipient is prompted to enter the unique alpha-numeric character string which is printed on the card. In the preferred embodiment, the unique alpha-numeric character string is printed in human-readable form under a scratch-off film on the POSA stored-value card. The scratch-off film prevents a casual observer of the card from seeing the alpha-numeric number until executing the online redemption. This provides an additional measure of security for the gift system.

Returning to the method, once at the web-site the gift recipient is instructed to scratch-off the protective film and type the revealed alpha-numeric character string into a web-field. Once the alpha-numeric string is entered, the recipient clicks a “next” button or otherwise indicates completion of the entering of the data string. At that point, the web-site system sends a query message to the activated card database seeking confirmation that the entered character string is active. If the activated card database returns a message that says the card was not activated, the web-site system returns a message screen via the recipient's browser stating that the card is not active and cannot be redeemed for a US savings bond and to re-enter an active card number. If the activated card database returns a message saying the card is properly activated, the web-site system returns another input screen to the recipient asking for the recipient's social security number along with appropriate information about the recipient including the recipients full name, email address, physical address and phone number. In one embodiment, if the card was sold without activation, the system would simply recognize that the entered number is valid in the database and returns the input screen.

Once the recipient enters the requested information, the system captures the information into its database and returns a message screen via the recipient's browser informing the recipient that the information was received and will be submitted for the issuance of US savings bond.

The web-site system also encompasses web links providing the recipient with access to any number of other web-pages explaining information about US savings bonds. In the preferred embodiment of the invention, these links lead to the US Treasury web-site relating to US savings bonds.

Next, in the preferred embodiment of the invention, the system batches the information entered by one or more recipients each day and sends the information to the appropriate Federal Reserve Bank for recording and issuance of the US savings bond. The information is delivered to the Federal Reserve Bank over a network in a format as dictated by the appropriate Federal Reserve Bank. The US Treasury or appropriate Federal Reserve bank sweeps the stored-value financial account to collect one-half the face value of the stored value gift card at the time of issuing the US savings bond. The gift system updates the data record for the recipient with the date and time of the transfer.

In one embodiment, the greeting card and POSA gift card include text instructions to the donor and recipient which explains how the stored-value is to be redeemed for the US savings bond gift on the US Treasury's web-site at www.TreasuryDirect.gov. The instructions optimally explain how the recipient may use any computer with web-browser to go to the www.TreasuryDirect.gov web-address. Once at the location, the gift recipient is prompted to establish an account at the US Treasury direct web site. The recipient is provided with an option on the US Treasury web site to enter the unique alpha-numeric character string which is printed on the card in lieu of entering bank account information. Once the alpha-numeric string is entered, the recipient clicks a “next” button or otherwise indicates completion of the entering of the data string. At that point, the US Treasury web-site system sends a query message to the activated card database seeking confirmation that the entered character string is active. If the activated card database returns a message that says the card was not activated, the web-site system returns a message screen via the recipient's browser stating that the card is not active and cannot be used to establish an account or be used to redeem a US savings bond. If the activated card database returns a message saying the card is properly activated, the US Treasury web-site system continues through its completion.

Once the recipient enters the requested information at the US Treasury web-site, the US Treasury system will debit the stored-value financial account, which optimally resides with the US Treasury in the form of a Certificate of Indebtedness (C of I). The gift system then updates the data record for the recipient with the date and time of the transfer.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a US savings bond gift system for offering, activating and redeeming a gift card for a US savings bond through an internet redemption process requiring a social security number.

FIG. 2 is a block flow diagram illustrating the method in accordance with the invention.

FIG. 3 is a diagram of a gift card which can be activated and redeemed for a US savings bond.

FIG. 4 is a sample greeting card which is purchased at the same time as the gift card.

FIG. 5 is a block flow diagram illustrating the gift card activation process using a retail point-of-sale system and an activation processor system.

FIG. 6 is a block flow diagram illustrating the recipient's stored-value redemption process

FIG. 7 is a diagram of a card database record format associated with a gift card.

FIG. 8a-e are sample web page forms used for the redemption process with one embodiment of the invention.

FIG. 9a-d are sample web page forms used for retail activation of the gift card with a web-enabled POS client with one embodiment of the invention.

FIG. 10 is a block flow diagram illustrating the method for activating and purchasing for a US savings bond gift card over the web using a web-enabled POS client in accordance with the invention.

FIG. 11 is a sample web-page screen showing redemption options for redeeming the stored value gift card during the establishment of an individual account at TreasuryDirect.gov.

### DETAILED DESCRIPTION OF THE PREFERRED EMBODIMENT

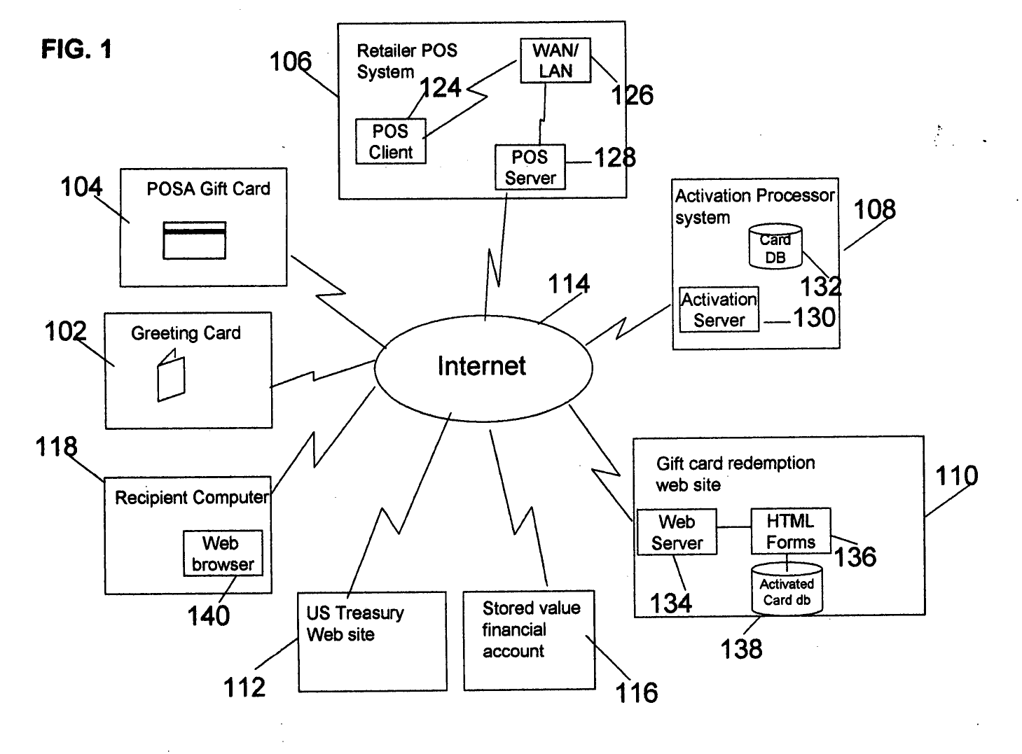

FIG. 1 is a high-level architectural drawing illustrating the primary components of a US savings bond gift system for selling a greeting card with stored-value card where the resulting stored value is redeemed for a US savings bond through HTML forms requiring a social security number and unique gift card number. The US savings bond gift system includes a greeting card 102, a Point-of-sale Activated gift card 104, a retailer's Point-of-sale system 106, a gift card activation processor system 108, a US savings bond gift card redemption web site 1 10, the US Treasury department web site 1 12, a stored-value account 116, a recipient's computer 118 and the internet 114 for linking the systems together.

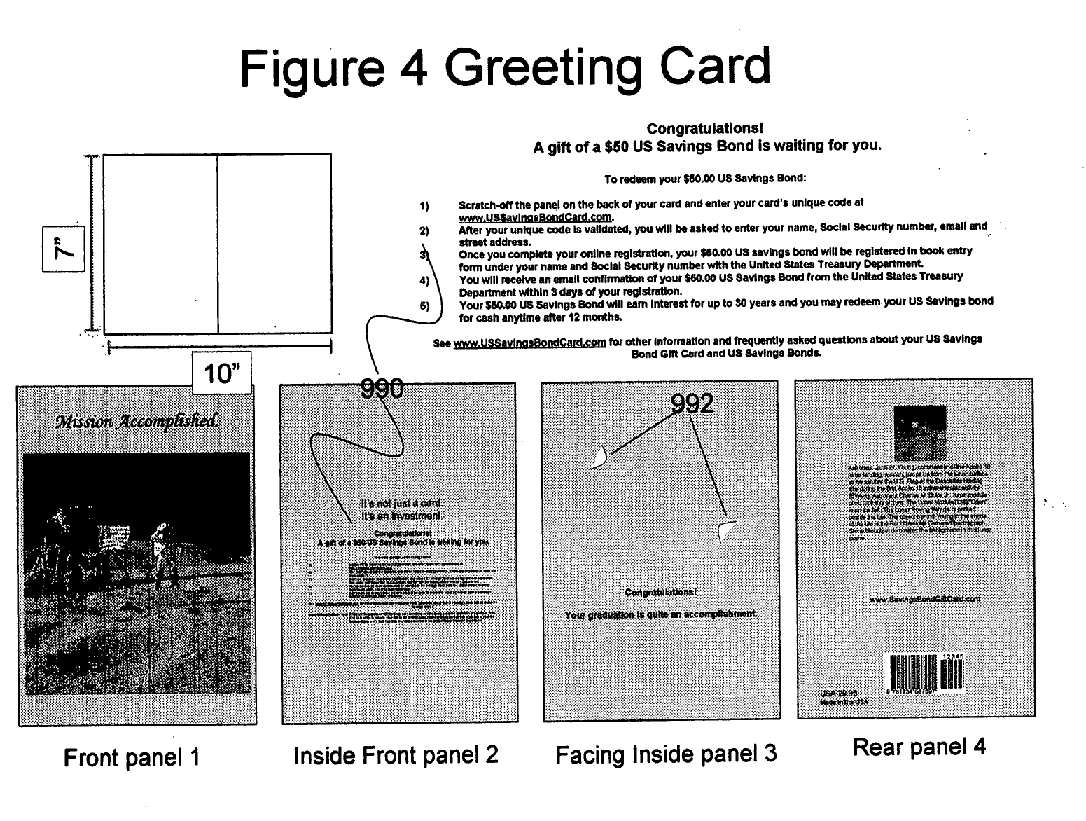

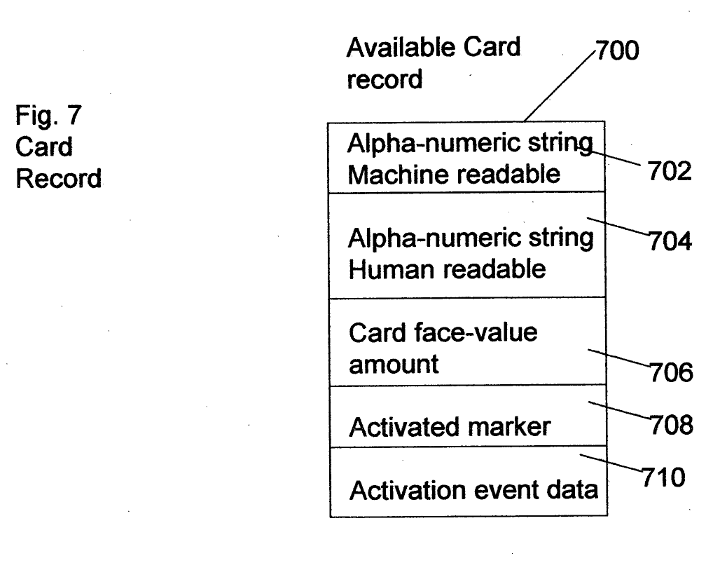

The greeting card 102 may be any type of printed greeting card such as a birthday, graduation, new birth, thank you or other printed card of any size. FIG. 4 is a sample greeting card. In the preferred embodiment of the invention, the greeting card 102-provides for physical coupling with the gift card 104. In one embodiment of the invention the mechanism for the greeting card 102 to be coupled with the gift card 104 is through die-cut slits placed on the third panel of the greeting card (FIG. 4 992) into which the gift card 104 (FIG. 7) can be inserted. A donor can place the opposite comers of the gift card 104 under the die-cut slits to secure the gift card 104 to the greeting card 102. Alternatively, the gift card 104 can be coupled to the greeting card 102 on any panel and through any method such as with a glue strip or via placement within the folded gift card or through any other coupling method so the gift card 104 is associated the greeting card 102. The greeting card 102 can be various sizes or shapes. In the preferred embodiment the gift card 102 is card stock folded to the standard five inch by seven inch greeting card format. FIG. 4 represents one embodiment of the greeting card 102. The greeting card 102 is intended to have a patriotic theme to further achieve one goal of patriotism for the donor and recipient. The greeting card 102 also includes standard printed instructions, 990 FIG. 4, explaining the US Bond redemption process for stored-value represented by the activated gift card 104. The instructions are an important element as they relay instructions to both a gift donor prior to purchase and to a gift recipient after the purchase. In one embodiment, the instructions can inform both parties of the redemption process and the face value of the gift card without relaying the stored-value amount.

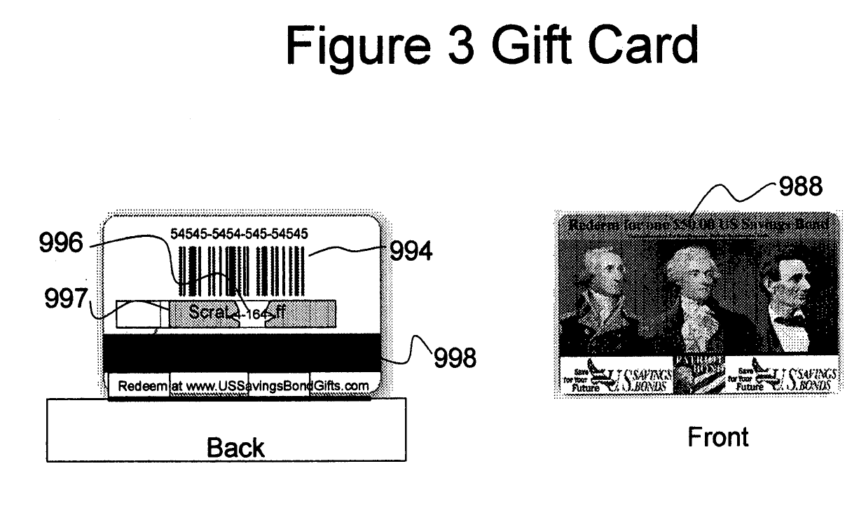

The gift card 104 is optimally a standard plastic laminated card with identifying numbers and instructions for redemption printed on the card. In the preferred embodiment of the invention the plastic card is a standard dimension of 3.375 inches by 2.125 inches and includes a magnetic stripe and/or machine readable bar-code and a scratch-off film covering a unique printed alpha-numeric string. FIG. 3 is a diagram of one embodiment of the gift card 104. The magnetic stripe (998, FIG. 3) provides for the magnetic encoding of a unique card number for the gift card 104. The card may also include, or alternatively include, the unique card number represented in a bar-code (994). The card also includes a second unique printed numeric character string (996) printed and covered by a scratch-off film (997). The printed numeric character string 996 can also be embossed or otherwise made human-readable on the gift card 104 The numeric character string (996) and the number encoded within the magnetic stripe (998) and/or bar-code (996) are unique and associated with just one gift card 104.

The retail point-of-sale system 106 is a composed of a POS client 124, Local or Wide Area Network (also known as LAN/WAN) 126 and POS server 128. The POS client 124 is capable of reading the magnetic stripe (998) or bar-code (996) on the gift card 102. The LAN/WAN 126 connects the POS client 124 to the POS server 128. The POS server 128 connects to the internet 114. In one embodiment, the retail point of sale system 106 records and processes information contained on the gift card 104. All major retailers and most individual retail stores have a retail point-of-sale system 106.

The card activation processor system 108 is a system tied to a network, such as the internet 114, accessible by the retailer's POS system 106. The card activation processor system 108 consists of an activation server 130 which accepts and process electronic messages from the retail POS system 106. The card activation processor system 108 also includes a card database 132 which contains unique records for each of the gift cards encoded with unique numbers. FIG. 7 is a diagram of a card database record which holds information relating to a unique gift card 102.

The Gift Card Redemption web site 110 advantageously includes a web server 134 and HTML documents 136, and an activated card database 138.

The preferred embodiment of this invention is a system and method for use with the Internet 114, a widely known global computer network. This invention is, however, not limited to the Internet. Thus, as used herein, the term “network” refers to any distributed computer network whether it be a local area network (LAN), a wide area network (WAN), or an Intranet.

The US Treasury web site 112 is the web site operated by the US Treasury as an authorized location to accept properly executed US savings bond applications and funds for issued US savings bonds.

The stored-value financial account 116 is a financial account for holding cash at a financial institution.

The recipient computer 118 may be any type of computing device that allows the recipient to interactively browse Web sites via a Web browser 140. For example, the seller computer 118 may be a personal computer (PC) that runs the Windows 2000 operating system running the Internet Explorer browser.

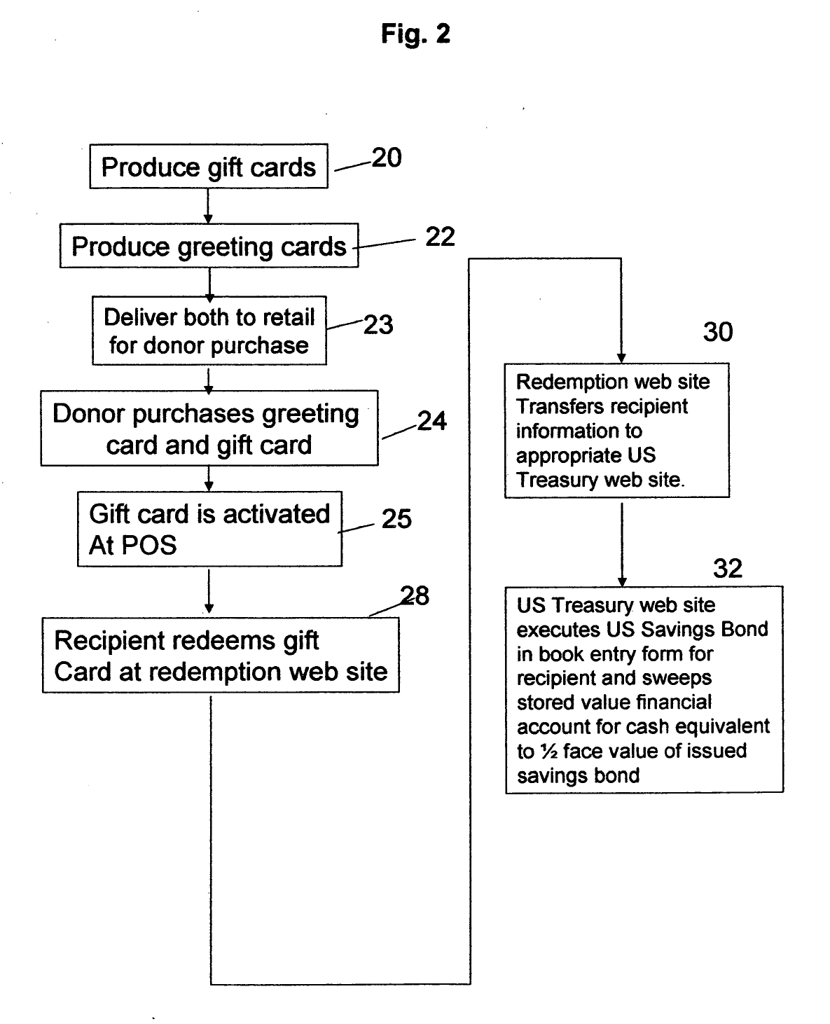

FIG. 2 is a general flow diagram of the method of this invention. Referring to this figure, the invention provides for the production of gift cards (FIG. 3), step 20. The production of the gift card 104 is similar to the production of any stored-value gift card or plastic embossed card and includes the printing of graphics on the front of the gift card which will identify a face value amount for a US savings bond for which the gift card may be redeemed by a gift recipient after activation. The back of the card will include printed instructions for initiating the redemption process the recipient will follow to redeem the gift card for the US savings bond. During the gift card production, step 20, card records (FIG. 7) are created and values are assigned to appropriate fields in each card record 700. Also during production, each physical card 104 (FIG. 3) is encoded with data from database fields for each card record 700 in the card database 132.

Referring to FIG. 7, each card record 700 in the card database 132 includes an alpha-numeric machine readable string 702, a separate alpha-numeric human readable string 704, an assigned card face-value amount 706, an activation marker set to N for not-activated and a blank field for recording activation event data.

The production of the gift card 104 further entails the encoding on the card the alpha-numeric string machine readable 702 within the magnetic stripe area of the gift card 104 and/or by printing the alpha-numeric string machine readable 702 as a bar-code on the back of the gift card 104. During production the alpha-numeric string human readable 704 is also printed on the back of the gift card 104. This alpha-numeric string human readable 704 is printed so it is readable by a human being. Each created alpha-numeric string human readable 704 and alpha-numeric string machine readable 702 is assigned to one and only one gift card 104 during production, from the card database 132. In the preferred embodiment of the invention, a scratch-off film is then layered over the gift card's alpha-numeric string human readable 704 hiding it from casual observation. In the preferred embodiment, the scratch-off film will be removed by the recipient at redemption and the alpha-numeric string human readable 704 will become visible to the recipient at that time. The combination of two unique alpha-numeric strings, one readable by machine and one readable by humans, provides a level of security in the gift system. Specifically, the alpha-numeric string machine readable 702 will be used at the point-of-sale to activate the card, and the alpha-numeric string human readable 704 (FIG. 3, 996) will be used at the redemption point. In one embodiment of the method, the card is not activated and only the alpha-numeric string human readable number 704 (FIG. 3, 996) is required for the card.

Next, step 22, the greeting card 102 (FIG. 4) is produced. The production of the greeting card 102 is similar to the production of any printed greeting card. However, in the preferred embodiment, two slits are cut into the third panel of the card to indicate the location a gift donor can place the gift card 104 within the greeting card 102. Also, instructions for redeeming the gift card 104 for a US savings bond are printed on the greeting card 102. Other methods, such as tipping the gift card 104 to the greeting card 102 with a glue strip are envisioned. Step 20 and step 22 are not chronologically dependent.

The greeting card 102 and the gift card 104 are both delivered to a retail location to await purchase by a gift donor, step 23.

At step 24, the greeting card 102 and gift card 104 are purchased by a donor at a retail location. The preferred embodiment of the invention provides for the greeting card 102 and the gift card 104 to be sold as a combined purchase by a gift donor. The invention encompasses this element to satisfy intended benefits of the invention. The invention is designed to satisfy the needs of a gift donor who wishes to purchase a US savings bond as gift for a gift-giving occasion such as a holiday, graduation, birthday, new birth, etc. The purchase combination of the gift card 104 and greeting card 102 as one transaction provides added value to the gift donor since the donor does not have to seek out and purchase a separate greeting card in addition-to the intended gift of the US savings bond. Moreover, the greeting card 102 can relay the necessary information for redemption to both the gift donor and the gift recipient who both have access to read the greeting card 102. The combination of the gift card 104 sold with the greeting card 102 also allows for a retail purchase price above what would be expected to be paid for the US savings bond or greeting card alone. For example, a greeting card 102 and gift card 104 redeemable for a $50 US savings bond might be sold for a combined price of $29.95. Alternatively, both items can be sold as separate transactions and it is intended that different combinations of gift cards with different face values will be sold with a greeting card. For example, a gift card with a face value for a US savings bond of $100 could be sold with a greeting card at a combined purchase price for example of $54.95 and a $200 face value gift card and greeting card could sell for $104.95.

The single purchase for the combined value of the gift card 104 and the greeting card 102, step 24, is a unique and innovative element of the gift system. It is important to note that other point-of-sale activated gift cards provide 100% of the face value to the recipient. In this invention, the face value of the gift card 104 is potentially equal to two times the stored value available for redemption. The face value on the gift card 104 will be less than the retail value of the combined gift card 104 and greeting card 102. Specifically, after the card is purchased and activated, the gift card 104 will represent a stored-value amount which can only be redeemed for a US savings bond as shown on the front of the gift card 104 during production (step 20). For example, a gift-card 104 with a face value for a US savings bond of $50.00 can be purchased and activated for $25.00, and the gift card redemption web site 110 will subsequently deposit only a cash amount in the stored value financial account 116 equal to $25.00. This is the traditional way US Savings bonds are priced and sold. However, another embodiment will of the invention allows for an equal purchase of a stored-value card for a US Savings bond. In this second embodiment, a $50.00 face value on the stored value card will provide for the purchase of a $50.00 US savings bond.

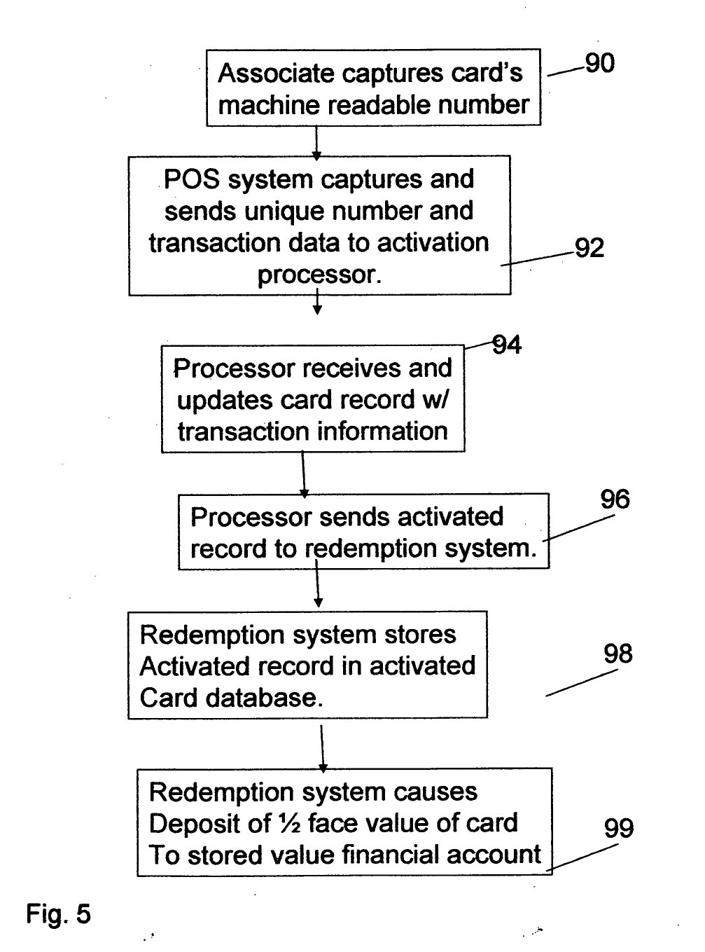

The gift card 104 is activated during the purchase transaction, step 25. FIG. 5, is a process flow diagram which details the steps involved in the activation transaction process. In one embodiment, no activation is required because fraud is not envisioned to be a major issue since the bond-holder needs to enter their social security number and name when purchasing the bond providing for easy identification if theft is suspected. Moreover, the purchased US savings bond may not be “cashed” for one year following purchase providing a further deterrent to fraud. Finally, the use of a single social security number to purchase multiple bonds can trigger an investigation.

Referring to FIG. 5, the retail associate captures the gift card's 104 unique alpha-numeric string machine readable 702 data, in step 90. The retail associate can capture the alpha-numeric string machine readable 702 data by swiping the card through a magnetic card reader or bar-code reader on the retail associate's POS client 124. The associate completes the activation as required by the retailer, usually by punching a series of keys at the POS client 124.

At step 92, the purchased gift card's unique alpha-numeric string machine readable 702 data along with any relevant transaction information such as date and time of purchase, store location ID, POS terminal ID or any other such information is routed by the POS client 124, through the retailer's POS system 106 via a local or wide area network 126 through the POS server 128 and over the internet 114 to the activation processor system 108.

At step 94, the activation processor system 108 receives the transaction activation information and updates the card record 700 associated with the purchased gift card 104 as recorded in the card database 132. Specifically, the activation processor system switches the activated marker field 708 to “active” and records the relevant transaction data into the activation event data field 710.

At step 96, the activation processor system 108 sends the complete newly activated card record 700 over the internet 114 to the redemption web site system 110.

At step 98, the redemption system web site 110 stores the newly activated record 700 into the activated card database 138 on the gift card redemption web site 110.

Alternatively to step 98, the activation processor system 108 may hold the activated card record 700 in the card database 132 and may provide activation status for any card record upon being polled by the gift card redemption web site 110 such as during recipient redemption.

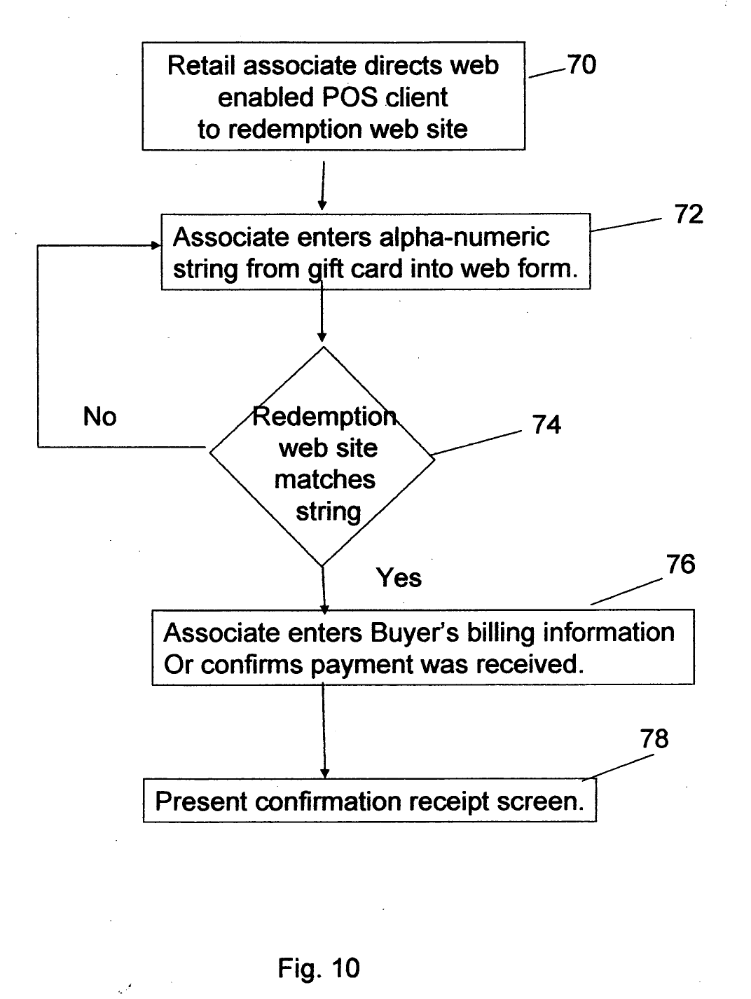

An alternative method available for use with the invention is detailed when a retail associate has access to a web-enabled POS client 124 connected to the internet 114. In this alternative method, the process to capture and activate the gift cards as outlined in steps 90 through 98,, can be replaced by having the retail associate point the web enabled POS terminal 124 directly to the gift card redemption web site 110 over the internet 114 for activation (step 25). The retail associate can then use the web-enabled POS terminal 124 to complete appropriate HTML forms 136 to activate the gift card 104 directly on the gift card redemption web site 110. In this alternative, the activated card database 138 houses all records, active or not active, from the card database 132 on the activation processor system 108. After pointing the web-enabled POS client 124 to the appropriate HTML form 136 on the gift card redemption web site 110, the retail associate is prompted to enter the alpha-numeric string machine readable 702 data by swiping the card through a magnetic card reader or bar-code reader on the retail associate's web enabled POS client 124 or by manually keying the alpha-numeric string machine readable 702 data into the appropriate form. FIG. 10 is a block flow diagram illustrating the method for activating and purchasing a US savings bond gift card over the web using a web-enabled POS client in accordance with the invention.

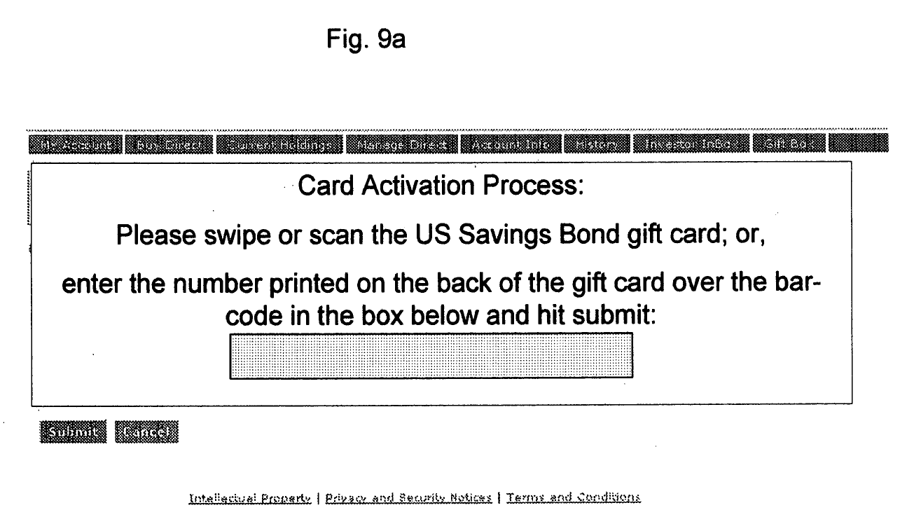

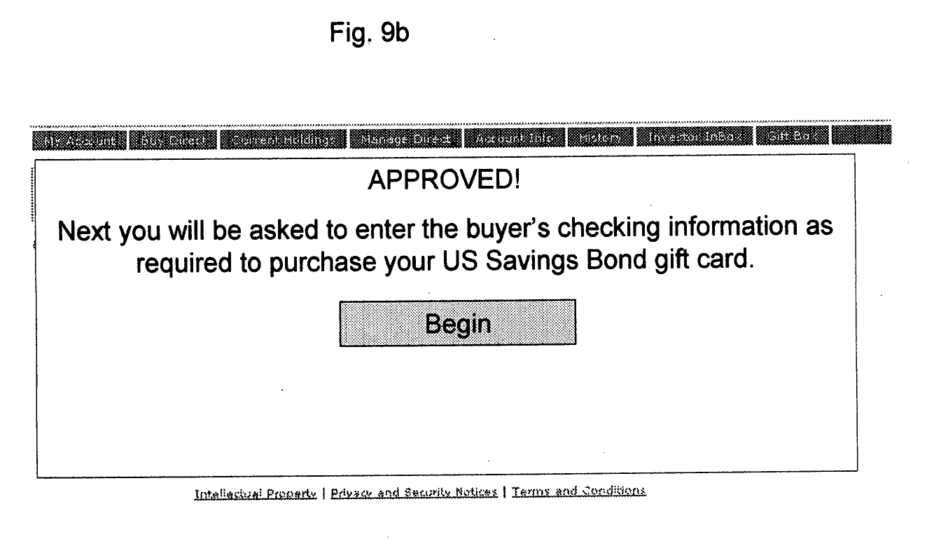

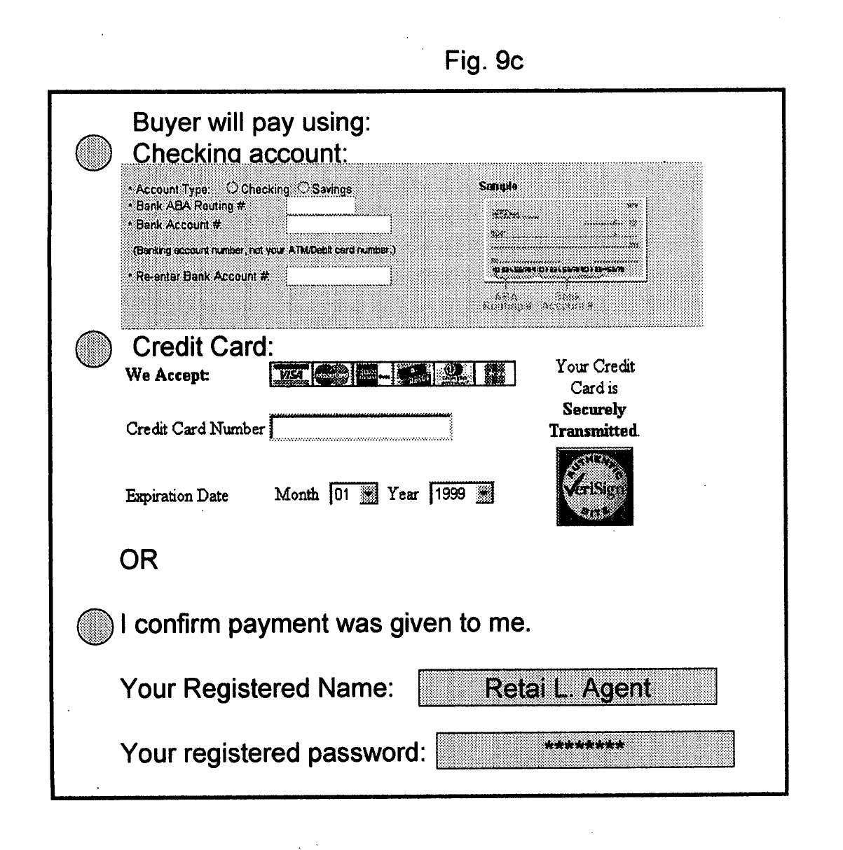

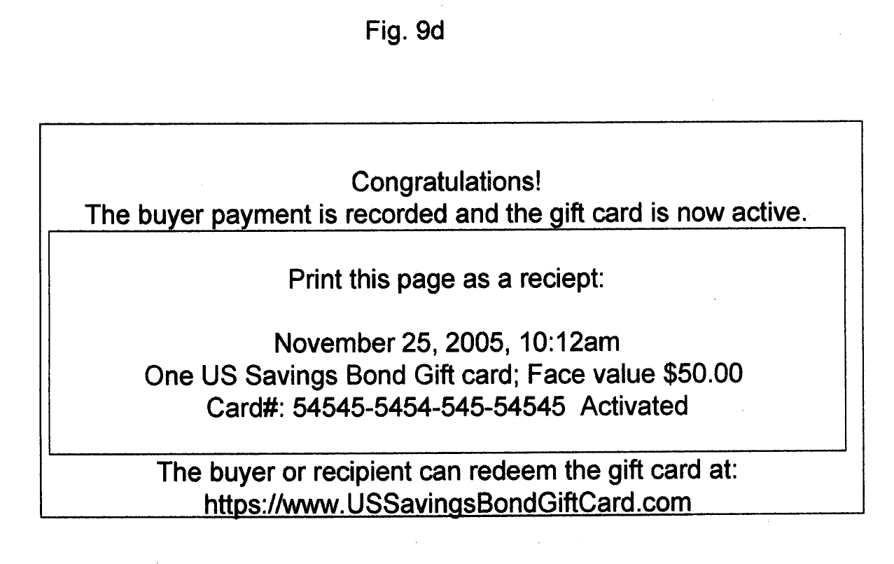

Referring to FIG. 10, step 70, the retail associate directs the web-enabled POS client 124 to the gift card redemption web site 110. At step 72, the associate is shown an HTML form 136 requesting the associate swipe the magnetic stripe or scan the bar-code or simply enter the alpha-numeric string machine readable 702 printed above the bar-code 994 on the back of the gift card 104 into the appropriate space on the HTML form and submit (FIG. 9a). FIG. 9a-d are sample HTML web-forms used in one embodiment of the invention.

At step 74, the gift card redemption web site 110 compares the entered alpha-numeric string to the alpha-numeric string machine readable 702 fields in the activated card database 138 for a possible match. If no match exists, the gift card redemption web site 110 prompts the retail associate to re-enter the alpha-numeric string machine readable 702. If a match does exist (FIG. 9b), the gift card redemption web site 110 moves to step 76, and presents HTML forms 136 (FIG. 9c) through the web server 134 and over the internet 114 to the web-enabled POS client 124 to receive the buyer's payment information or to allow the retail associate to confirm payment was received.

In step 78, a confirmation HTML form (FIG. 9d) is presented to the retail associate confirming payment was properly recorded, the gift card 104 was activated and provides further instruction for recipient redemption.

Returning to FIG. 5, at step 99, next the gift card redemption web site 110 causes a deposit equal to one-half the gift card 104 face value to be made into the stored value financial account 116. The face value amount is read from the card face value amount field 706 in the card record 700 housed on the activated card database 138. To cause the deposit, the gift card redemption web site 110 issues a message in the appropriate form for a bank transfer to be executed in the specified funds into the stored value financial account 116. The deposit is made at the time of activation because the gift recipient can immediately move to redeem the activated gift card for a US savings bond. Traditionally, US Savings Bonds are sold at a discount of one-half the face value of the bond. However, other embodiments envision the sale at the full face value of the stored value card being equal to the full purchase price of the bond.

The US Treasury requires funds to be available in the stored value financial account 116 at the time of issuance of the US savings bond. Failure to have the proper stored value on hand will result in significant penalties and potentially the loss of an issuing agent's license.

After activation, the gift card 104 can only be redeemed for a single US savings bond of the specific stored value associated with that redeemed gift card.

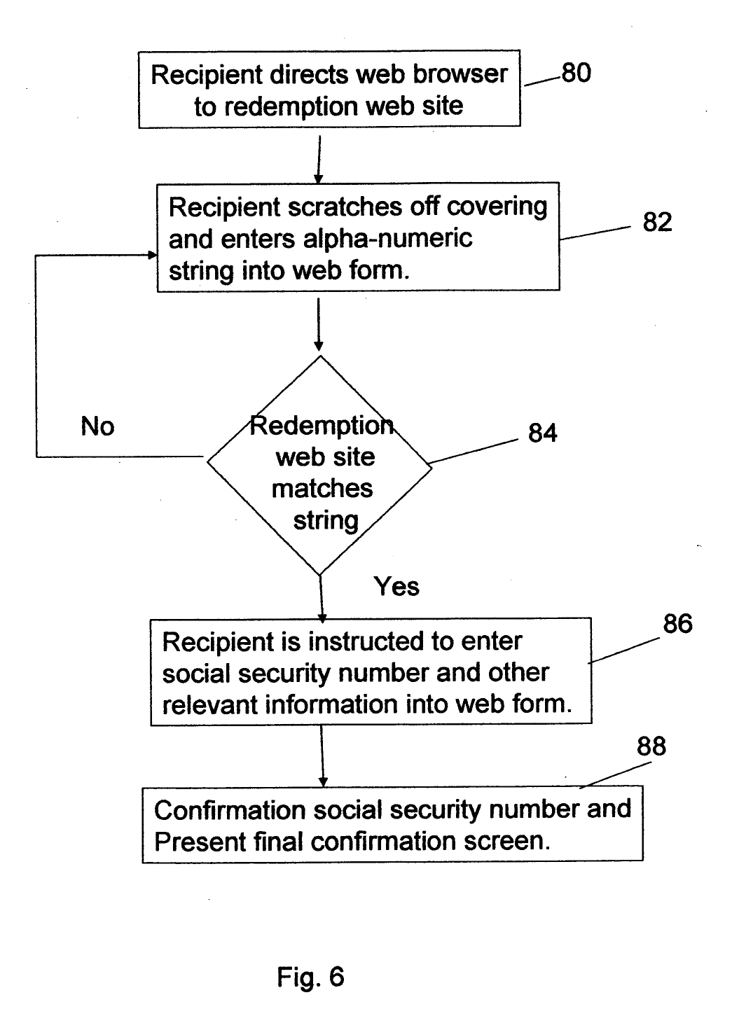

Returning to FIG. 2, the system provides for the redemption of the activated gift card 104 by the recipient in step 28. FIG. 6 is a detailed process flow diagram outlining the recipient redemption process.

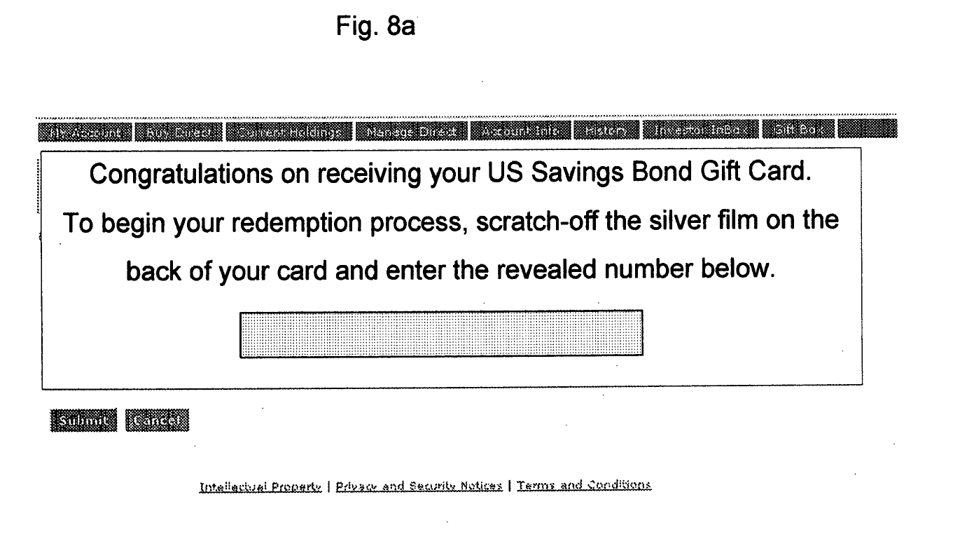

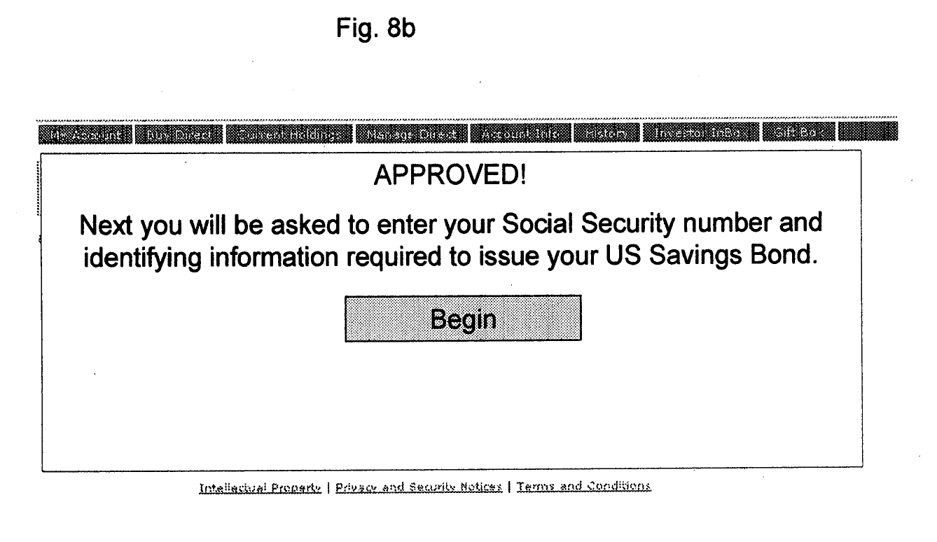

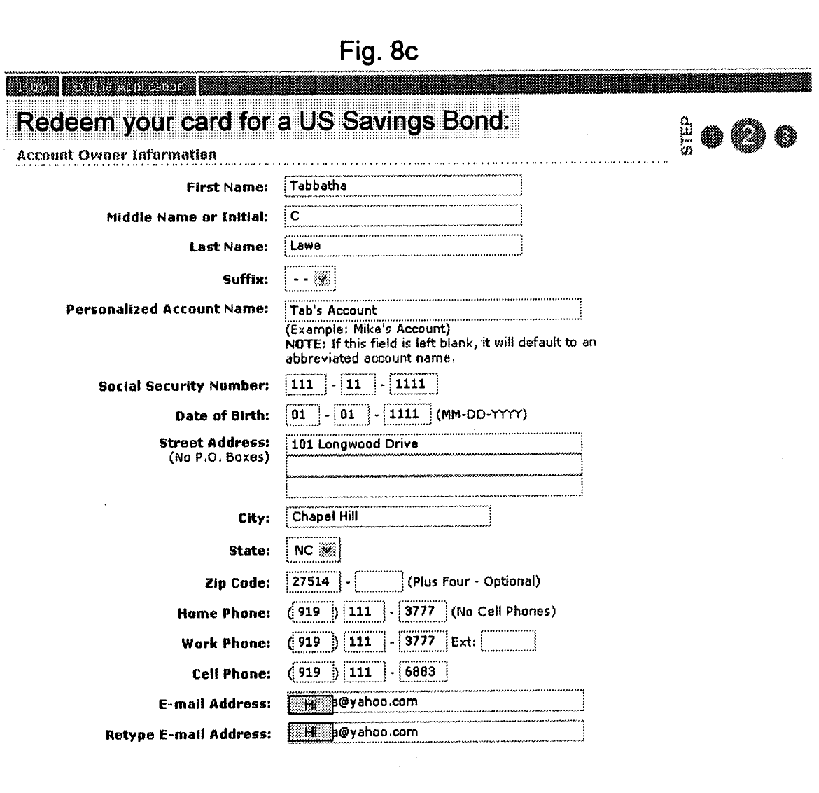

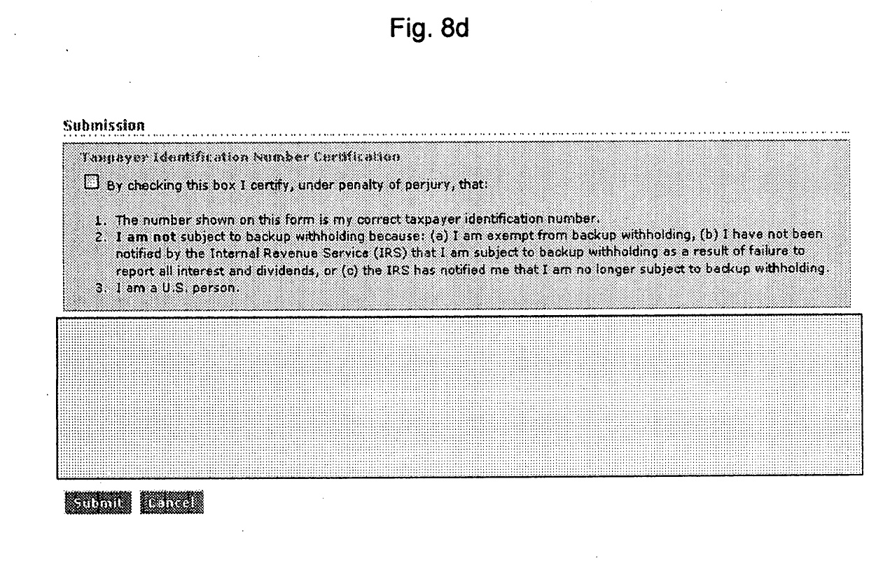

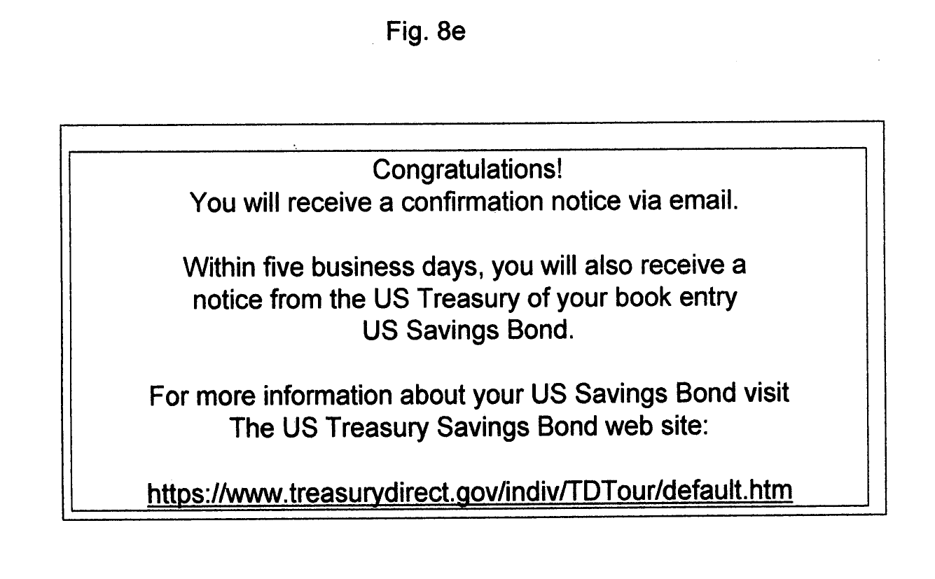

Referring to FIG. 6, step 80, the gift card 104 recipient uses the recipient's computer 118 and directs the web browser 140, to the gift card redemption web site 110. At step 82, the recipient is shown an HTML form 136 requesting the recipient to scratch-off the film (996, FIG. 3) covering the printed alpha-numeric string 996 on the back of the gift card 104 and to enter the alpha-numeric string human readable 704 number into the appropriate space on the HTML form and submit (FIG. 8a). FIG. 8a-e are sample HTML web-forms used in one embodiment of the invention.

At step 84, the gift card redemption web site 110 compares the recipient's entered string to the alpha-numeric string human readable 704 fields in the activated card database 138 for a possible match. If no match exists, the gift card redemption web site 110 prompts the recipient to re-enter an activated alpha-numeric string human readable 704. If a match does exist (FIG. 8b), the gift card redemption web site 110 moves to step 86, and presents HTML forms 136 (FIG. 8c) through the web server 134 and over the internet 114 to the recipient computer 118 to receive the recipient's social security number and other pertinent data.

It is a critical element of the invention that the social security number be recorded during redemption. The invention cannot operate without the social security number of the recipient. It is believed that no other gift card systems require the recipient to enter a social security number for redemption of a stored-value gift card. The importance of the entering of the recipient's social security number is of such significance that, in step 88, an additional HTML form (FIG. 8d) is presented to the recipient seeking the recipient's confirmation that the social security number, otherwise known as the recipient's tax ID, entered is the correct social security number/tax ID for the recipient and that there are no outstanding tax judgements against the person owning the Social Security number. Once confirmation is received, a final confirming web page (FIG. 8e) is presented and the recipient redemption (step 28) is complete. The final presented web page (FIG. 8e) also contains links to more details and information about US savings bonds which satisfies a need in the marketplace for such information.

Returning to FIG. 2, after the recipient has redeemed the gift card in step 28, the social security number and other relevant information from the recipient is sent by the Gift card redemption web site 110 to the US Treasury Web Site 112 over the internet 114 for issuance of the US savings bond, step 30. In one embodiment, this sending is first made through an issuing agent bank who in turn sends the information to the Federal Reserve bank or to the US Treasury. In step 32, the US Treasury Web Site executes the US savings bond for the recipient by recording the US savings bond in book entry under the recipient's social security number and name; and by the US Treasury sweeping the stored value financial account 116 for one-half the face-value of the issued US savings bond. If the full-face value of the POSA card is indicated as available to purchase a bond, the sweep is for the full amount.

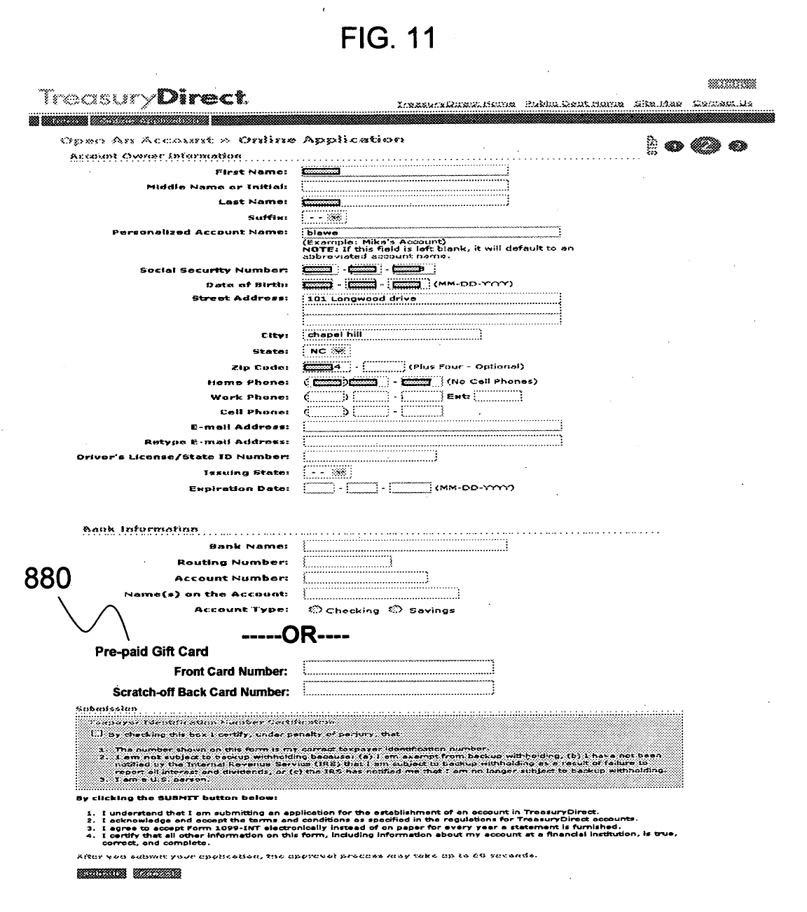

In an alternate embodiment, the instructions on the greeting card (FIG. 4, 990) on the greeting card 102, instruct the recipient to redeem the stored value card 104 when purchasing a bond at the US Treasury web-site (e.g. TreasuryDirect.gov). In this embodiment, in lieu of visiting the gift card redemption web site (110) the recipient opens an account at a US Treasury website (112) such as TreasuryDirect.gov and in lieu of providing a bank account, the recipient can use the stored-value card to create the account and purchase the bond. FIG. 11 shows a sample web-page at the US Treasury web-site allowing for the use of the POSA gift card (104) during the establishment of a US Treasury account and in the purchase of a US savings bond at the US Treasury web-site.

It will be appreciated by those skilled in the art that numerous modifications and variations are possible, and that the invention may be practiced otherwise than as specifically described herein, without departing from the scope thereof.

1-23. (canceled)

24. A US savings bond gift system, comprising:
a. a greeting card with a point-of-sale activated gift card comprising at least two unique alpha-numeric character strings, redeemable for a US savings bond; and,
b. a retail point-of-sale system capable of activating a point-of-sale activated gift card; and
c. an activation processor system, capable of receiving an activation notice and transmitting an activated card record; and
d. a gift card redemption web site, capable of receiving a point-of-sale activated card record and redeeming a purchased point-of-sale activated gift card through input of a recipient's social security number and one unique alpha-numeric character string from the point-of-sale activated gift card, for a US savings bond equal to one-half the face-value of the activated gift card.
e. a stored-value financial account, capable of holding a stored-value cash amount equal to one-half of the face-value of the point-of-sale activated gift card; and
f. a US Treasury web site, capable of issuing a US savings bond and sweeping the stored-value financial account for the cash amount equal to one-half the face-value of the issued US savings bond; and
g. a recent's computer with web browser, capable of viewing and completing online forms to redeem the point-of-sale activated gift card for a US savings bond.

25. The system of claim 24 in which said stored-value financial account is held at a US Treasury issuing agent bank.

26. The system of claim 24 in which said stored-value financial account is held at the US Treasury.

27. The system of claim 24 in which said gift card redemption web site is resident within an US Treasury issuing agent bank's website.

28. The system of claim 24 in which said US Savings bond is purchased for the equivalent value of the activated gift card.

29. The system of claim 24 in which said US Treasury web site is capable of sweeping the stored-value financial account for the full cash amount of the face value of the issued US savings bond.

30. An automated method, performed by a computer-based US savings bond gift system to provide for the issuing of a US savings bond after redemption of a stored-value gift card, said gift card sold with a greeting card, said sale activating said gift card, said activation including the recording of said gift card activation on a card database and causing a deposit of one-half the face value of the gift card into a stop-value account, said card database used to validate said gift card during redemption, said redemption requiring input of at least a social security number and said gift card number, said social security number sent to a US Treasury web site for issuing of said US savings bond,
the method comprising:
producing said gift card comprising two unique alpha-numeric character strings and a US savings bond face-value amount printed on the face of the card;
producing a greeting card with instructions for redeeming said gift card for a US savings bond;
a donor purchasing said greeting card and said gift card in a transaction;
said gift card activating during said purchase transaction by transmitting at least one alpha-numeric character string from the gift card to an activation processor system;
a recipient redeeming said gift card at a gift card redemption web site for a US savings bond by inputting at least a social security number and one alpha-numeric character string on the gift card;
said gift redemption web site causing the deposit of one-half the face-value amount printed on the face of the card in a stored value financial account;
a US Treasury web site receiving said social security number and sweeping said stored value financial account for an amount equal to one-half the face-value printed on the gift card; said US Treasury web site issuing said US Savings bond to the recipient.

31. The method of claim 30 where the redemption is through an issuing agent bank authorized by the US Treasury to sell US savings bonds.
